(19) United States
(12) Patent Application Publication
(10) Pub. No.: US 2026/0205223 A1
(43) Pub. Date: Jul. 16, 2026

(54) USING AN ADAPTIVE THRESHOLD FOR MCS TABLE SELECTION

(71) Applicant: Dell Products, L.P., Round Rock, TX (US)

(72) Inventors: Sean Xiao, Toronto (CA); Ravi Sharma, Cupertino, CA (US); Vikas Arora, Ottawa (CA)

(21) Appl. No.: 19/020,065

(22) Filed: Jan. 14, 2025

(51) Int. Cl. H04L 1/00; H04L 5/00

(52) U.S. Cl. CPC H04L 1/0016; H04L 5/006

(57) ABSTRACT

Architectures and techniques are provided for intelligently selecting a modulation coding scheme (MCS) table that is to be used for a connection between an access point (e.g., a distributed unit) and a user equipment (UE). Based on an initial signal-to-noise ratio (SNR) value between the access point and UE and data points determined from previous connections involving the access point or a given cell of the access point an adaptive access point-specific SNR threshold can be determined. This SNR threshold can evolve over time based on the collected data and can be used to choose a particular MCS table for subsequent connections.

### BACKGROUND

For wireless communication, such as that specified by Third Generation Partnership Project (3GPP), the communication between a user equipment (UE) and a wireless access point (e.g., a distributed unit (DU) of a gNodeB (gNB)) relies on predefined modulation and coding scheme (MCS) tables. There are multiple different MCS tables that may be selected, and each MCS table provides a different set of predefined combinations of modulation orders and code rates used to transmit data over the air interface such as those using Fifth Generation (5G) new radio (NR) systems. Thus, an MCS table can be used to efficiently allocate resources to the UE and to adapt to varying channel conditions. Upon designation of the particular MCS table to be used for a given connection, the UE makes reference to the designated MCS table to determine modulation scheme, code rate, and spectral efficiency for associated transmissions.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram 100 that illustrates an example disaggregated node that leverages a modulation and coding scheme (MCS) table to provide access to a UE in accordance with some example embodiments of this disclosure;

FIG. 2 depicts a schematic block diagram that illustrates various examples of MCS table in accordance with some example embodiments of this disclosure;

FIG. 3 depicts a graphical plot that illustrates an example distribution of MCS table indexes for both the 64-QAM table and the 256-QAM table plotted over a signal-to-noise ratio (SNR) in accordance with some example embodiments of this disclosure;

FIG. 4 depicts a call flow diagram that illustrates example steps involved in swapping to a different MCS table 114 in accordance with some example embodiments of this disclosure;

FIG. 5 depicts a schematic block diagram illustrating an example device that can provide an MCS table selection based on an adaptive or learned SNR threshold value in accordance with certain embodiments of this disclosure;

FIG. 6 depicts a schematic block diagram illustrating additional aspects or elements of the device of FIG. 5 that can select an MCS table based on the adaptive SNR value;

FIG. 7 depicts an example plot diagram illustrating a plot of combined data for a given DU or DU cell in accordance with some example embodiments of this disclosure;

FIG. 8 depicts an example table illustrating certain aspects of the combined data that are grouped by the initial SNR value in accordance with some example embodiments of this disclosure in accordance with some example embodiments of this disclosure;

FIG. 9 depicts an example graph illustrating the target threshold being identified as the lowest point on a curve of frequency of total flags in accordance with some example embodiments of this disclosure in accordance with some example embodiments of this disclosure;

FIG. 10 illustrates an example method 1000 that can provide MCS table selection based on an adaptive or learned SNR threshold value in accordance with certain embodiments of this disclosure;

FIG. 11 illustrates an example method 1100 that can provide for additional elements in connection with MCS table selection based on an adaptive or learned SNR threshold value in accordance with certain embodiments of this disclosure;

FIG. 12 illustrates an example block diagram of a computer operable to execute example embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

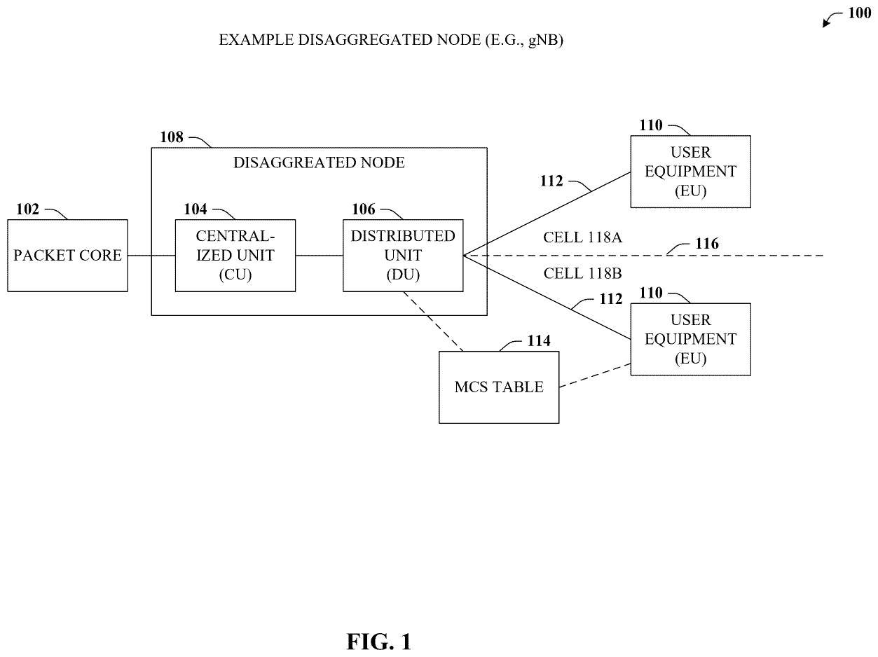

In order to better understand the subject matter detailed herein, it can be instructive to consider an example disaggregated node configured to provide wireless access to a user equipment (UE). FIG. 1 depicts a schematic block diagram 100 that illustrates an example disaggregated node 108 that leverages a modulation and coding scheme (MCS) table 114 to provide access to UE 110 in accordance with some example embodiments of this disclosure. As an example, disaggregated node 108 can be a gNodeB (gNB) that communicates with one or more devices of a packet core 102 (e.g., an evolved packet core).

In that regard, disaggregated node 108 can represent a node in a cellular network that provides connectivity between UE 110 and packet core 102. Disaggregated node 108 can represent a functional equivalent of a base station or other wireless access point of a traditional communication network. As illustrated, disaggregated node 108 can be disaggregated into distinct entities referred to as a centralized unit (CU) 104 and one or more distributed unit(s) (DU) 106.

Generally, CU 104 can be implemented as a virtualized or cloud-based entity that is responsible for higher layer data processing (e.g., scheduling, packet handling, . . . ), control plane function, and otherwise controlling DU 106 or multiple different DUs 106. DU 106 typically comprises physical equipment (e.g., antenna, tower, . . . ) that is responsible for lower layer data processing (e.g., radio transmission, reception, . . . ) and otherwise controlling some subset of radio signals. DU 106 can be connected to CU 104 or other DU 106 through fronthaul and midhaul networks. DU 106 can also directly communicate with UE 110 within range. As illustrated DU 106 can provide connectivity to multiple UE 110, some of which can be in different physical cells 118 of the associated coverage area. For example, some subset of UE 110 can be physically extant in cell 118A, while other UE 110 can be in cell 118B, as illustrated by cell boundary 116.

During initial signaling 112, DU 106 can establish a connection with UE 110. In some embodiments, the connection can be a radio resource control (RRC) connection. During the RRC connection or other initial connection, a given MCS table 114 can be designated to be used for communication between DU 106 and UE 110. As indicated above, multiple MCS tables exist, each having predefined combinations of modulation orders and code rates, which are respectively intended to provide communication efficiency for a particular set of radio frequency (RF) conditions existing between DU 106 and UE 110.

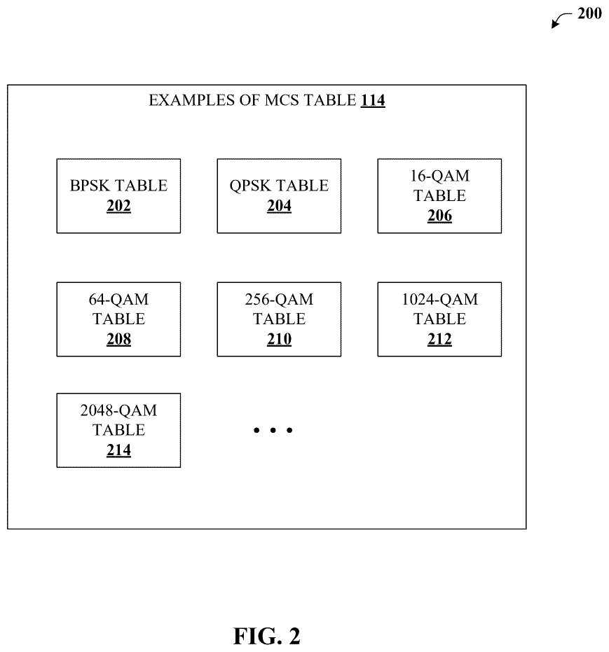

For example, while still referring to FIG. 1, but turning now as well to FIG. 2, a schematic block diagram 200 is depicted that illustrates various examples of MCS table 114 in accordance with some example embodiments of this disclosure. It is to be understood that the indicated examples are intended to be examples and are not limiting, as other example MCS tables 114 can exist beyond the few examples listed here.

For instance, MCS table 114 can be a binary phase shift keying (BPSK) table 202 that can be used to transmit binary data over a communication channel. As another example, MCS table 114 can be a quadrature phase shift keying (QPSK) table 204 that can transmit 2 bits per symbol by varying one of four phase state. MCS table 114 can also relate to various quadrature amplitude modulation (QAM) schemes that can leverage a of process of modulating the amplitudes of two carrier waves that are 90 degrees out of phase with one another to convey information.

As shown, there are many types of QAM tables, including 16-QAM table 206, 64-QAM 208, 256-QAM 210, 1024-QAM 212, 2048-QAM table 214, and so on. QAM schemes rely on a number of symbols, bits per symbol, and a constellation size. As an example, 64-QAM has 64 symbols and supports 6 bits per symbol, whereas 256-QAM has 256 symbols and supports 8 bits per symbol, and so on, meaning that the higher order QAM can transmit more data per symbol. Likewise, 64-QAM has a constellation size of 64, whereas 256-QAM has a constellation size of 256, and so on. A higher order constellation size can result in more dense constellation, which may by more susceptible to noise and interference.

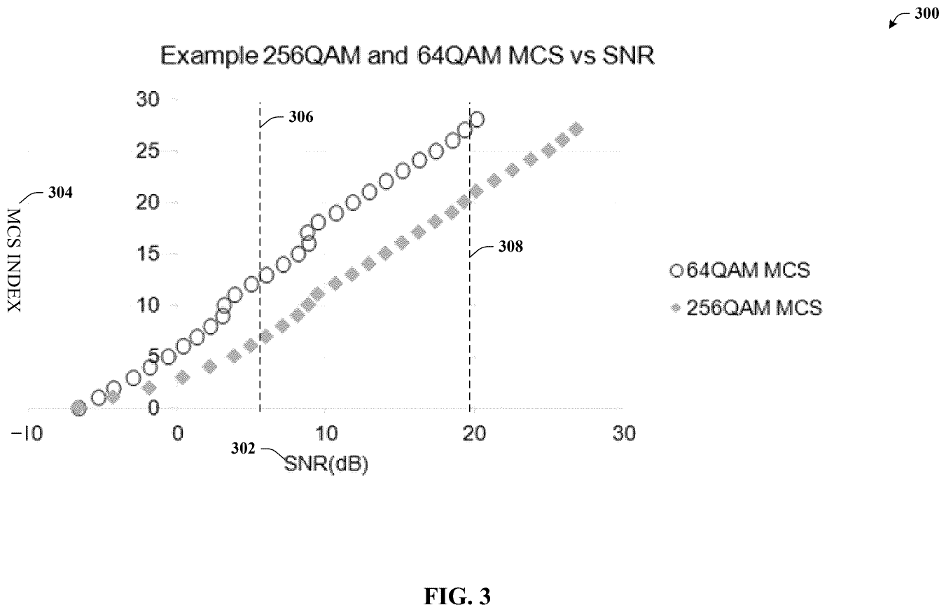

In other words, selection of 256-QAM table 210 will generally provide better throughput than selection of 64-QAM table 208 provided the RF signal quality between DU 106 and UE 110 is high, but may readily be outperformed by 64-QAM table 208 if RF signal conditions are low. Such is further illustrated in connection with FIG. 3.

With reference now to FIG. 3, a graphical plot 300 is depicted that illustrates an example distribution of MCS table indexes 304 for both the 64-QAM table 208 and the 256-QAM table 210 plot versus a signal-to-noise ratio (SNR) values 302 in accordance with some example embodiments of this disclosure.

As is illustrated in graphical plot 300, different MCS indexes 304 can be preferred and/or optimized within a given table to be used for different SNR values 302 that are reported periodically by the system. Thus, transmissions between DU 106 and UE 110 can be based on a table lookup by MCS index 304, which can be determined by the SNR value 302. As shown, given a particular SNR value 302, the MCS index 304 will be different depending on whether 64-QAM table 208 is being used or 256-QAM table 210 is being used.

Furthermore, it can be readily visualized that 256-QAM table 210 is not configured to be especially efficient at low SNR ranges illustrated by low threshold 306. On the other hand, 64-QAM table 208 does not have any additional MCS indexes 304 available to target high SNR values 302 above about 20 decibels (dB), and thus cannot take advantage of high quality connections at or above high threshold 308.

Practically, what this means is that if the signal quality between DU 106 and UE 110 are below low threshold 306, 64-QAM table 208 will likely provide better performance, whereas, otherwise, 256-QAM table 210 will likely provide better performance. In fact, above high threshold 308, 64-QAM table 208 does not provide any additional signal quality benefits, whereas 256-QAM table 210 does via several MCS indexes 304 allocated for that range that is in addition to the advantage of having more bits per symbol.

Still referring to FIG. 1, it can be readily appreciated that selecting a particular MCS table 114 from among the many MCS tables 114 that are available can have a significant impact on the quality of service, throughput, and other related metrics associated with service provided to UE 110.

However, certain challenges arise. For example, the quality of signaling 112 between DU 106 and UE 110 commonly varies during the lifetime of a single connection due in part to mobility, system load, environmental factors, and other factors. However, in order to utilize advanced signaling features (e.g., as opposed to ‘fall back’ recovery features), MCS table 114 typically must be designated at the outset of a connection (e.g., during an initial RRC configuration). Once designated, the same designated MCS table 114 is thereafter used for the lifetime of the connection.

As can be appreciated, due to changing conditions, it could be useful to swap the initially selected MCS table 114 with a different MCS table 114 to take better advantage of current conditions. However, in order to change MCS table 114, an additional RRC configuration procedure is typically required. Such brings extra overhead and potentially increases call drop risk. Hence, in most cases, changing the MCS table 114 during a given call is not a desirable option.

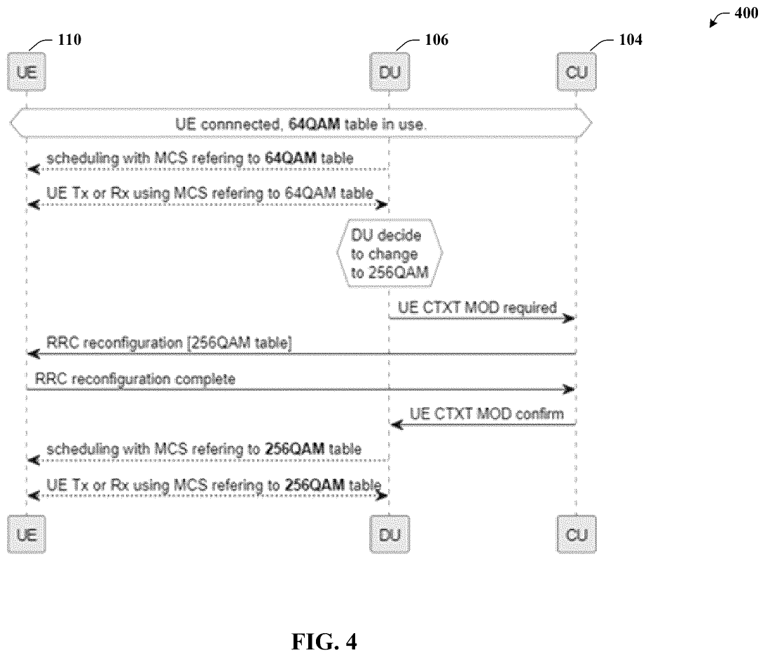

For example, FIG. 4 depicts a call flow diagram 400 that illustrates example steps involved in swapping to a different MCS table 114 in accordance with some example embodiments of this disclosure. In this example, an originally selected 64-QAM table 208 is swapped to a 256-QAM table 210, e.g., to take advantage of high quality signaling 112 extant between DU 106 and UE 110. As has already been discussed, such typically relies on a new RRC configuration procedure, which can be expensive and can lead to dropped connections.

Thus, because changing the MCS table 114 during a given call is not a desirable option, the disclosed subject matter is, in some embodiments, directed to more intelligently selecting an MCS table 114 at the outset based on an adaptive threshold. In some embodiments, the adaptive threshold can be an SNR threshold value, which is used as a representative example for the remainder of this document. However, it is understood that SNR is merely one example, as the adaptive threshold could be based on other suitable noise, signal quality, or other similar metrics.

In some embodiments, the adaptive threshold can be an adjustable or configurable threshold value that can be dynamically updated or learned and further can be tailored for a given DU 106 or a given cell 118 of a given DU 106.

### Example Systems

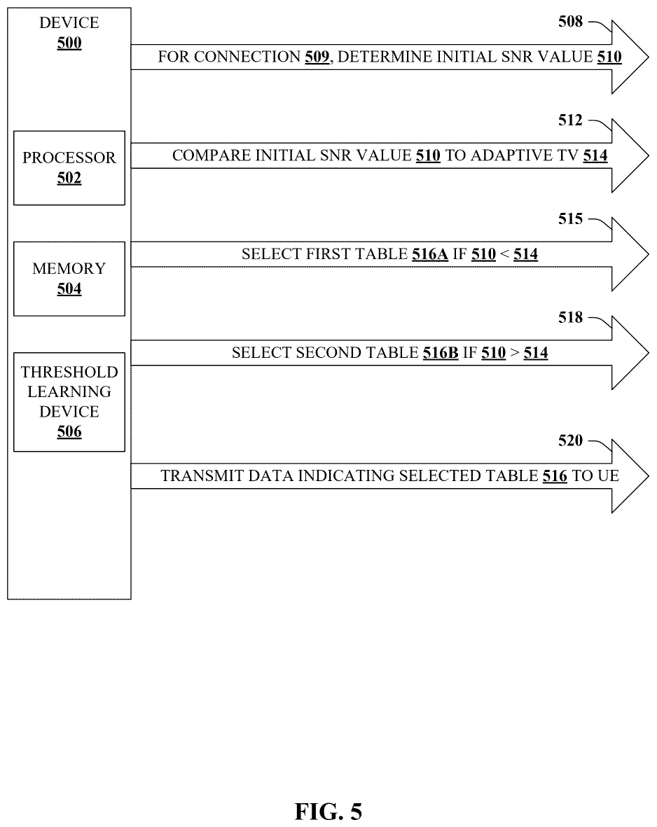

With reference now to FIG. 5, a schematic block diagram illustrating an example device 500 that can provide MCS table 114 selection based on an adaptive or learned SNR value in accordance with certain embodiments of this disclosure. In some embodiments, device 500 can be included in or communicatively coupled to a base station or disaggregated node 108. For example, in some embodiments, all or a portion of device 500 can included is a DU such as DU 106.

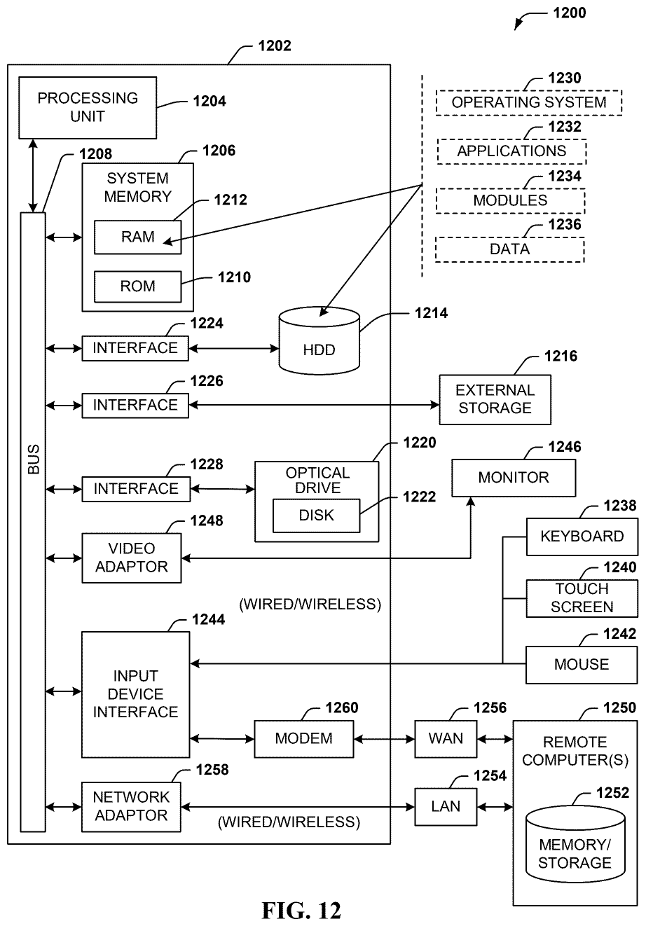

Device 500 can comprise a processor 502 that, potentially along with threshold learning device 506, can be specifically configured to perform functions associated with using an adaptive threshold value to select an advantageous MCS table and/or determining the adaptive threshold value. Device 500 can also comprise memory 504 that stores executable instructions that, when executed by processor 502, can facilitate performance of operations. Processor 502 can be a hardware processor having structural elements known to exist in connection with processing units or circuits, with various operations of processor 502 being represented by functional elements shown in the drawings herein that can require special-purpose instructions, for example, stored in memory 504 and/or threshold learning device 506. Along with these special-purpose instructions, processor 502 and/or threshold learning device 506 can be a special-purpose device. Further examples of the memory 504 and processor 502 can be found with reference to FIG. 12. It is to be appreciated that device 500 or computer 1202 can represent a server device or a client device of a system and computer 1202 can be used in connection with implementing one or more of the systems, devices, or components shown and described in connection with FIG. 5 and other figures disclosed herein.

At reference numeral 508, for a given connection 509 between an access point device (e.g., DU 106) and a UE (e.g., UE 110), device 500 can determine an initial SNR value 510. For example, the initial SNR value 510 can be reported during an initial RRC connection configuration process.

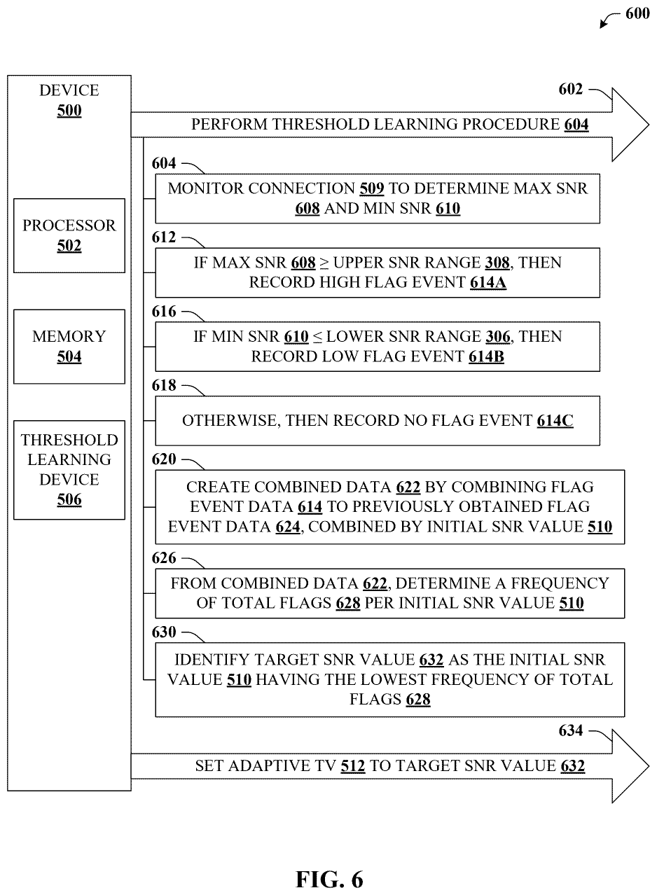

At reference numeral 512, device 500 can compare initial SNR value 510 to adaptive threshold value 514. As will be further detailed in connection with FIG. 6 and other subsequent drawings, adaptive threshold value 514 can be learned or otherwise determined as a function of previous connections involving DU 106 or other access point device. Hence, adaptive threshold value 514 can be specifically tailored to any given DU 106 or even a given cell 118 of DU 106 based on associated data that was previously stored relating to connections involving that particular DU 106 and/or that particular cell 118 of the DU 106.

As indicated at reference numeral 515, device 500 can select first table 516A if initial SNR value 510 is less than adaptive threshold value 514. Alternatively, device 500 can select second table 516B if initial SNR value 510 is greater than or equal to adaptive threshold value 514. For the remainder of this disclosure, as a representative example, 64-QAM table 208 is used as first table 516A while 256-QAM table is used as second table 516B. Thus, the above described comparison can select between any potential MCS tables 114 that are available as a function of a comparison between the initial SNR value 510 and the adaptive threshold value 514.

Moreover, the adaptive threshold value 514 can vary and/or can be learned to advantageously represent expected conditions for a given DU 106 based on historical conditions that can be recorded an aggregated as part of the learning process, which is further detailed in connection with FIG. 6 and other FIGS. Hence, adaptive threshold value 514 can represent a potentially optimal or best threshold for an associated DU 106 for deciding when to initially favor one MCS table 114 over one or more other MCS tables 114. Thereafter, as illustrated at reference numeral 520, device 500 can transmit data to the UE (e.g., during an RRC configuration process) indicating the selected table 516. In other words, in this example, the data would indicate one of either first table 516A (e.g., 64-QAM table 208) or second table 516B (e.g., 256-QAM table 210).

With reference now to FIG. 6, a schematic block diagram 600 is depicted illustrating additional aspects or elements of device 500 that can select an MCS table based on the adaptive SNR value 514 in accordance with some example embodiments of this disclosure.

For example, at reference numeral 602, device 500 can perform threshold learning procedure 604. Threshold learning procedure 604 can be configured to identify or update adaptive SNR value 514. As further explained below, such learning can be specific to a given DU 106 or to a given portion of DU 106, such as a given cell 118 of DU 106.

At reference numeral 604, as part of threshold learning procedure 604, device 500 can monitor connection 509. Such monitoring can be periodic or continuous and can be maintained for the life of connection 509. The monitoring can relate to determining a maximum SNR 608 reading (e.g., over the life of connection 509 between DU 106 and UE 110) and an associated minimum SNR 610 reading. Hence, for each connection between DU 106 and UE 110 (potentially in a given cell 118), the following three values can be recorded: initial SNR value 510, maximum SNR 608, and minimum SNR 610.

Thereafter, device 500 can then determine what is referred to herein as flag even data 614, which can be established based on certain relevant criteria being met, which is detailed in connection with reference numerals 612-618. For example, at reference numeral 612, device 500 can record a high flag event 614A in response to a determination that maximum SNR 608 is greater than or equal to a particular SNR range associated with MCS tables 114. For example, such can be upper range 308 discussed in connection with FIG. 3. In this example, such would be about 20 dB, so if maximum SNR 608 is greater than or equal to about 20 dB, then a high flag event 614A can be recorded.

At reference numeral 616, device 500 can record a low flag event 614B in response to a determination that minimum SNR 610 is less than or equal to a different SNR range associated with MCS tables 114. For example, such can be lower range 306 discussed in connection with FIG. 3. In this example, such would be about 6 dB, so if minimum SNR 610 is less than or equal to about 6 dB, then a low flag event 614B can be recorded.

It is understood that either one, both, or neither the high flag event 614A and the low flag event 614B can occur based on the values obtained from the monitoring that were recorded with respect to reference numeral 604. In the case where neither flag event occurred (e.g., neither 614A nor 614B), then, as indicated at reference numeral 618, device 500 can record no flag event 614C.

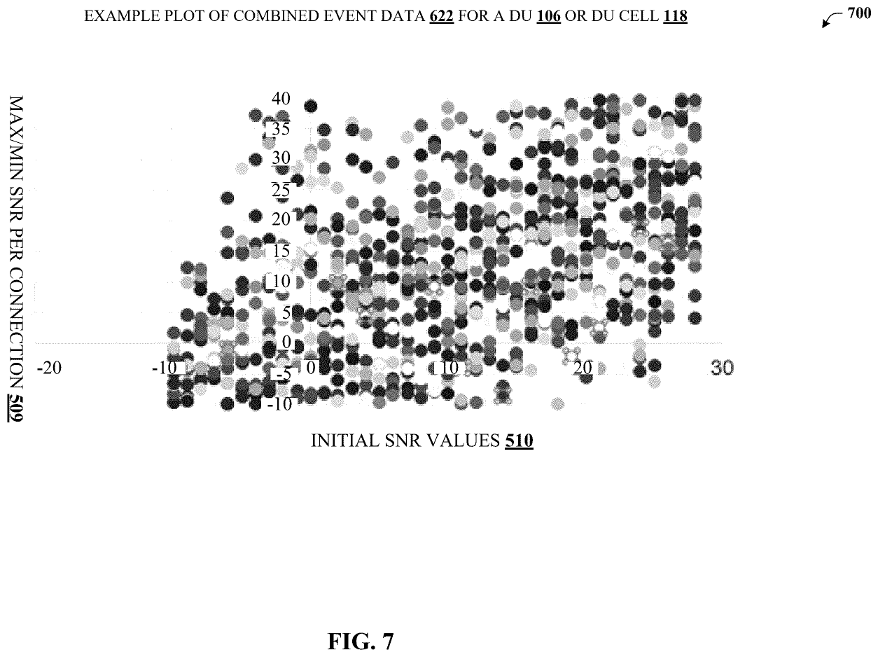

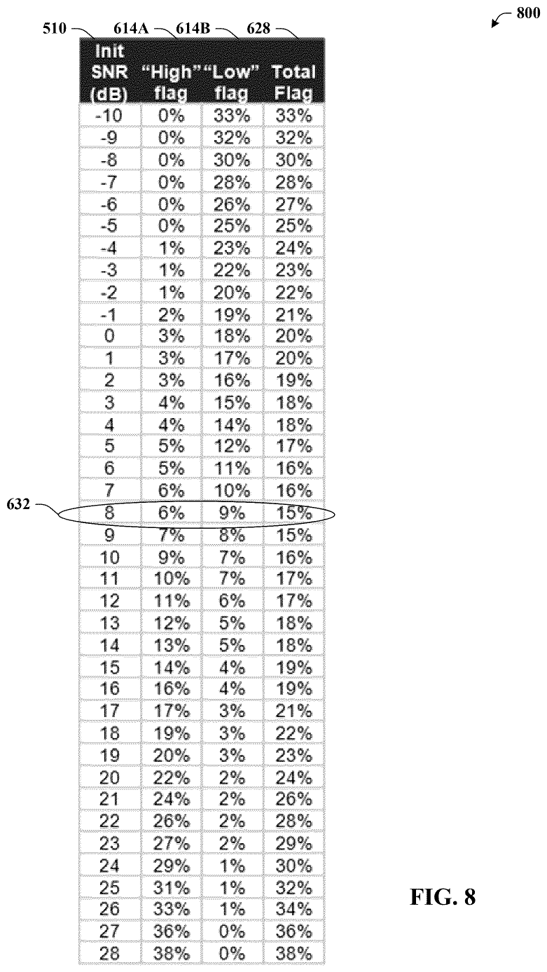

Once this flag event data 614 has been collected for connection 509, such can be combined with previously obtained flag event data 624 that can be representative of other connections involving DU 106 but not necessarily the same UE 110, potentially collected by cell 118. Thus, combined data 622 can represent a record of all or a portion of past connections involving DU 106 or a particular cell 118 of DU 106 so that combined data 622 can relate specifically to that particular DU 106 or associated portion thereof. Combined data 622 can be grouped according to initial SNR value 510 as illustrated in connection with FIGS. 7 and 8.

FIG. 7 depicts an example plot diagram 700 illustrating a plot of combined data 622 for a given DU 106 or DU cell 118 in accordance with some example embodiments of this disclosure. For example, for each connection 509, the associated maximum SNR 608 and minimum SNR 610 can be plotted at a location on the x-axis determined by the associated initial SNR value 510. The y-axis location can be indicated by the respective actual values of maximum SNR 608 and minimum SNR 610. It is understood that combined data 622 can include data from one or both uplink and downlink scenarios.

Still referring to FIG. 6, but turning now as well to FIG. 8, an example table 800 is depicted illustrating certain aspects of combined data 622 that is grouped by initial SNR value 510 in accordance with some example embodiments of this disclosure. In this example, rows of table 800 are sorted in ascending order by initial SNR value 510. Thus, each different connection 509 can contribute to the value of other columns (e.g., high flag events 614A, low flag events 614B, total flag events, . . . ) that are in the same row, that is, the group (e.g., row) that had the same initial SNR value 510 reported when connection 509 was being established.

Thus, as indicated at reference numeral 626 of FIG. 6, device 500 can determine a frequency of total flags per initial SNR value 510. In other words, for each initial SNR value 510 of combined data 622, the associated data (e.g., from DU connections having that particularly initial SNR value 510) can be used to determine respective frequencies of the following, which can be inserted into table 800: high flag events 614A frequency, low flag events 614B frequency, and frequency of total flag events 628.

By way of illustration, frequency of total flag events 628 can be the sum of high flag events 614A frequency and low flag events 614B frequency. Various frequencies or percentages of associated flag events can be determined by dividing the number of a particular flag event by a sum of the total number of flags and the number of no flag events 614C.

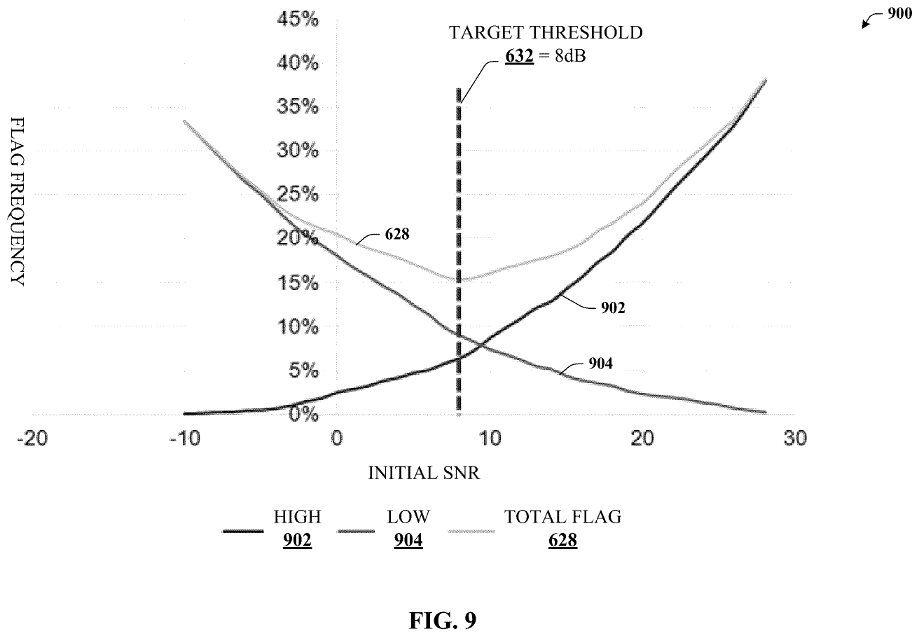

At reference numeral 630, device 500 can identify target SNR value 632 as the initial SNR value 510 (e.g., from table 800) having the lowest frequency of total flags 628. The encircled row in table 800 illustrates the target SNR value 632, because that row represents the lowest frequency (about 15%) of total flags 628. Another way of stating the above is that among all relevant connections 509, those that registered an initial SNR value 510 of 8 dB had combined to have the fewest (as a percentage) flag events, which is graphically illustrated with reference to FIG. 9.

FIG. 9 depicts an example graph 900 illustrating the target threshold 632 being identified as the lowest point on a curve of frequency of total flags 628 in accordance with some example embodiments of this disclosure in accordance with some example embodiments of this disclosure;

Graph 900 shows a curve of several frequencies, including frequencies 902 relating to high event flags 614A by initial SNR 510 and frequencies 904 relating to low event flags 614B by initial SNR 510. More significant, however, are frequencies of total flags 628, which troughs at 8 dB. Thus, 8 dB can be selected as target threshold 632. Further, as shown at reference numeral 634 of FIG. 6, device 500 can set adaptive threshold value 512 to target SNR value 632. Thus, adaptive threshold value 512 can be tailored to a specific DU 106 based on the particular characteristics of that DU 106.

Advantageously, a given learned adaptive threshold value 512 can then be compared to an initial SNR value 510 (e.g., as part of an RRC connection configuration process) as detailed in connection with FIG. 5. Hence, in this example, if that initial SNR value 510 is greater than or equal to 8 dB, then 256-QAM table 210 can be selected, but otherwise the 64-QAM table 208 can be selected. Such can represent a more intelligent and productive technique for MCS table 114 selection.

For example, using these techniques, UE 110 can benefit from higher reliability in weaker RF environments, but still leverage high throughput performance in good RF conditions. Moreover, a potentially optimal MCS table 114 can be selected as part of any RRC setup procedure, while reducing or minimizing additional RRC reconfiguration overhead in order to, e.g., switch MCS tables 114.

With regard to the adaptive learning, such can be tailored to individual DUs 106 or specific cells 118 of a given DU 106, any of which can operate in different environments and under different constraints. Such automated learning can remove the need to perform post launch optimization activities, manual adjustments, and drive tests for optimization.

### Example Methods

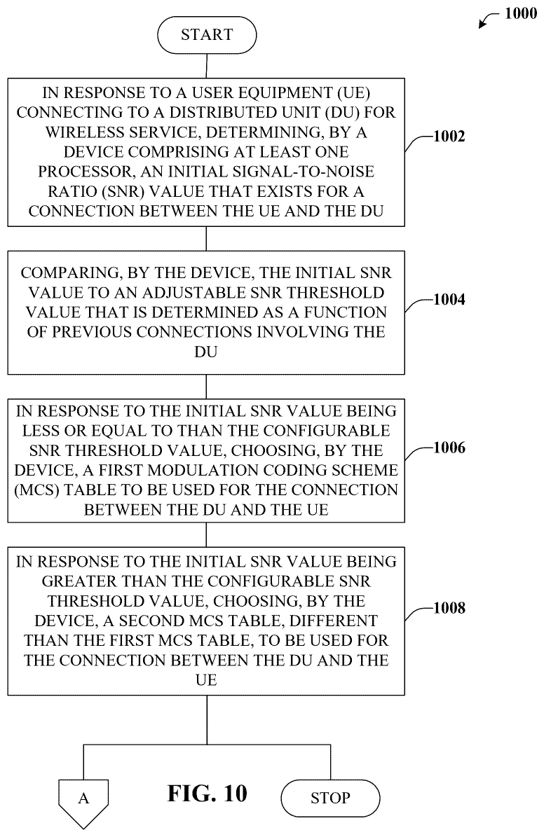

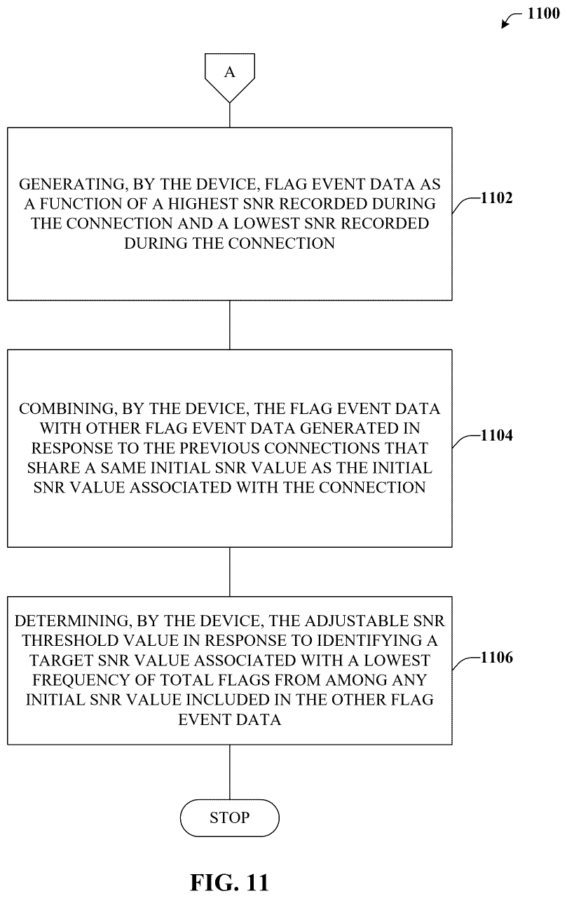

FIGS. 10 and 11 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 10, exemplary method 1000 is depicted. Method 1000 can provide MCS table selection based on an adaptive or learned SNR threshold value in accordance with certain embodiments of this disclosure. While method 1000 describes a complete method, in some embodiments, method 1000 can include one or more elements of method 1100, as illustrated by insert A.

At reference numeral 1002, in response to a UE connecting to a DU for wireless service, a device comprising at least one processor can determine an initial SNR value that exists for a connection between the UE and the DU. In some embodiments, this initial SNR value can be reported as part of an RRC connection setup procedure.

At reference numeral 1004, the device can compare the initial SNR value to an adjustable SNR threshold value that is determined as a function of previous connections involving the DU. The previous connections involving the DU can be all previous connections or a subset of previous connections such as those with UE from a particular DU cell.

At reference numeral 1006, in response to the initial SNR value being less or equal to than the configurable SNR threshold value, choosing, by the device, a first MCS table to be used for the connection between the DU and the UE.

At reference numeral 1008, in response to the initial SNR value being greater than the configurable SNR threshold value, choosing, by the device, a second MCS table, different than the first MCS table, to be used for the connection between the DU and the UE. Method 1000 can terminate or continue to insert A, which is further detailed in connection with FIG. 11.

Turning now to FIG. 11, exemplary method 1100 is depicted. Method 1100 can provide for additional elements in connection with MCS table selection based on an adaptive or learned SNR threshold value in accordance with certain embodiments of this disclosure.

At reference numeral 1102, the device introduced at reference numeral 1002 comprising at least one processor can generate flag event data. Flag event data can be generated as a function of a highest SNR recorded during the connection and a lowest SNR recorded during the connection. For example, if the highest SNR equals or exceeds a given high SNR threshold, then a high flag event can be recorded. Additionally, if the lowest SNR is at or below a given low SNR threshold, then a low flag event can be recorded. In some embodiments, if neither flag event occurs, then a no flag event can be recorded.

At reference numeral 1104, the device can combine the flag event data with other flag event data. The other flag event data can be generated in response to the previous connections that share a same initial SNR value as the initial SNR value associated with the connection.

At reference numeral 1106, the device can determine the adjustable SNR threshold value in response to identifying a target SNR value. For example, the target SNR value can be associated with a lowest frequency of total flags from among any initial SNR value included in the other flag event data.

### Example Operating Environments

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In this regard, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated example embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or” and it therefore interchangeable with the term “and/or”. That is, unless specified otherwise, or clear from context, “X employs A or B” (or any like example) is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to a user equipment (UE) connecting to a distributed unit (DU) for wireless service, determining an initial signal-to-noise ratio (SNR) value for a connection between the UE and the DU;
comparing the initial SNR value to an adaptive SNR threshold value that is determined as a function of previous connections involving the DU;
in response to the initial SNR value being determined to be less than the adaptive SNR threshold value, selecting a first modulation coding scheme (MCS) table to be used for the connection between the DU and the UE; and
in response to the initial SNR value being determined to be greater than or equal to the adaptive SNR threshold value, selecting a second MCS table, different than the first MCS table, to be used for the connection between the DU and the UE.

2. The device of claim 1, wherein the connection between the UE and the DU is a radio resource control connection.

3. The device of claim 1, wherein the first MCS table and the second MCS table are different members of a group comprising at least two of a binary phase shift keying (BPSK) table, a quadrature phase shift keying (QPSK) table, a 16-quadrature amplitude modulation (QAM) table, a 64-QAM table, a 256-QAM table, a 1024-QAM table, or a 2048-QAM table.

4. The device of claim 1, wherein the operations further comprise, in response to the first MCS table being selected and further in response to a determination that a first modulation code that exists in the first MCS table is being used, performing an MCS table switching procedure that instructs the DU and the UE to use the second MCS table, and wherein the first modulation code is a code associated with an upper SNR range of the first MCS table.

5. The device of claim 1, wherein the operations further comprise, in response to the second MCS table being selected and further in response to a determination that a second modulation code that exists in the second MCS table is being used, performing an MCS table switching procedure that instructs the DU and the UE to use the first MCS table, and wherein the second modulation code is a code associated with a lower SNR range of the second MCS table.

6. The device of claim 1, wherein the operations further comprise performing a threshold learning procedure that identifies or updates the adaptive SNR value in a manner that is specific to the DU, or a cell of the DU.

7. The device of claim 6, wherein the threshold learning procedure comprises monitoring the connection to determine a maximum SNR recorded for the connection and a minimum SNR recorded for the connection.

8. The device of claim 7, wherein the threshold learning procedure comprises determining flag event data, comprising:
in response to the maximum SNR being determined to be greater than or equal to an upper SNR range of the first MCS table, recording a high flag event;
in response to the minimum SNR being determined to be less than or equal to a lower SNR range of the second MCS table, recording a low flag event; and
in response to neither the low flag event nor the high flag event being determined to be occurring, recording a no flag event.

9. The device of claim 8, wherein the threshold learning procedure comprises determining combined event data by combining the flag event data that results from the connection to other flag event data resulting from the previous connections involving the DU based on the initial SNR value, resulting in the flag event data being combined with the other flag event data having a same initial SNR value.

10. The device of claim 9, wherein the threshold learning procedure comprises determining, from the combined event data, respective frequencies of total flag events for respective initial SNR values, and wherein the respective frequencies of the total flag events represent respective combinations of all high flag events per respective initial SNR value and all low flag events per respective initial SNR value.

11. The device of claim 10, wherein the threshold learning procedure comprises determining a target SNR value from among the respective initial SNR values, and wherein the target SNR value has a lowest frequency of the respective frequencies of the total flag events.

12. The device of claim 11, wherein the threshold learning procedure comprises setting the adaptive SNR threshold value to equal the target SNR value.

13. A method, comprising:
in response to a user equipment (UE) connecting to a distributed unit (DU) for wireless service, determining, by a device comprising at least one processor, an initial signal-to-noise ratio (SNR) value that exists for a connection between the UE and the DU;
comparing, by the device, the initial SNR value to an adjustable SNR threshold value that is determined as a function of previous connections involving the DU;
in response to the initial SNR value being less or equal to than the configurable SNR threshold value, choosing, by the device, a first modulation coding scheme (MCS) table to be used for the connection between the DU and the UE; and
in response to the initial SNR value being greater than the configurable SNR threshold value, choosing, by the device, a second MCS table, different than the first MCS table, to be used for the connection between the DU and the UE.

14. The method of claim 13, further comprising generating, by the device, flag event data as a function of a highest SNR recorded during the connection and a lowest SNR recorded during the connection.

15. The method of claim 14, further comprising combining, by the device, the flag event data with other flag event data generated in response to the previous connections that share a same initial SNR value as the initial SNR value associated with the connection.

16. The method of claim 15, further comprising determining, by the device, the adjustable SNR threshold value in response to identifying a target SNR value associated with a lowest frequency of total flags from among any initial SNR value included in the other flag event data.

17. A non-transitory computer-readable medium comprising instructions that, in response to execution, cause a system comprising a processor to perform operations, comprising:
in response to a user equipment (UE) connecting to a distributed unit (DU) for wireless service, determining an initial signal-to-noise ratio (SNR) value that exists for a connection between the UE and the DU;
comparing the initial SNR value to an adaptive SNR threshold value that is determined as a function of previous connections involving the DU;
in response to the initial SNR value being less than the adaptive SNR threshold value, selecting a first modulation coding scheme (MCS) table to be used for the connection between the DU and the UE; and
in response to the initial SNR value being greater than the adaptive SNR threshold value, selecting a second MCS table, different than the first MCS table, to be used for the connection between the DU and the UE.

18. The non-transitory computer-readable medium of claim 17, wherein the operations further comprise monitoring the connection to determine a maximum SNR recorded for the connection and a minimum SNR recorded for the connection.

19. The non-transitory computer-readable medium of claim 18, wherein the operations further comprise determining flag event data, comprising:
in response to the maximum SNR being greater than or equal to an upper SNR range of the first MCS table, recording a high flag event;
in response to the minimum SNR being less than or equal to a lower SNR range of the second MCS table, recording a low flag event; and
in response to neither the low flag event nor the high flag event occurring, recording a no flag event.

20. The non-transitory computer-readable medium of claim 19, wherein the operations further comprise:
generating combined event data comprising a combination of the flag event data with other flag event data resulting from the previous connections involving the DU, and, based on the combined event data, determining the adaptive SNR threshold value as a function of a lowest frequency of total flag events represented in the combined event data.
